(19) United States
(12) Patent Application Publication
(10) Pub. No.: US 2004/0078563 A1
(43) Pub. Date: Apr. 22, 2004

(54) Remotely programmable electronic lock and process ASP software to generate and track key activity

(76) Inventors: John Kimes, Lake Arrowhead, CA (US); Leo Felipe, Costa Mesa, CA (US); Kerry Hirschy, Orlando, FL (US); Nancy Miron, Royal Oak, MI (US)

Correspondence Address: Kwadjo Adusei-Poku, Masco Corporation, 21001 Van Born Road, Taylor, MI, 48180, US

(21) Appl. No.: 10/656,980

(22) Filed: Sep. 5, 2003

Related U.S. Application Data
(60) Provisional application No. 60/409,257, filed on Sep. 9, 2002.

(51) Int. Cl. H04L 9/00

(52) U.S. Cl. 713/155

(57) ABSTRACT

A remote security key encoding system comprising a client system containing a client identity, a client location and client account information, a service provider system connected to the client system via an Internet connection, and a financial institution system, connected to the client system and the service provider system via the Internet. When, over the Internet a client requests the encoding of a security key, the service provider system identifies the client, authenticates the client location, confirms that the client's account status is above some predetermined threshold, and encodes the security key per the client request. The client has the option of paying in advance for the key encoding services, and may replenish the client account at any time by logging onto the service provider's system.

### RELATED APPLICATIONS

This application claims the benefit of U.S. Provisional Application No. 60/409,257 filed on Sep. 9, 2002.

### FIELD OF THE INVENTION

A remote security key encoding system comprising a client system containing a client identity, a client location and client account information, a service provider system connected to the client system via an Internet connection, and a financial institution system, connected to the client system and the service provider system via the Internet.

### BACKGROUND OF THE INVENTION

This invention relates to a process for remotely encoding security keys via a secure, remote server over the Internet. According to the invention, a user, proprietor or subscriber may code security keys for controlling entry security doors using the Internet to access a remote server that houses the encoding software. Services are delivered via an Internet Service Provider (ISP) to the subscribers.

One area in which this invention is applicable is in the hospitality industry. The security doors on hotels use security keys that are programmed to allow access by predetermined authorized personnel as programmed by the property. Typically, the authorized personnel for a given room, on a given day, would be the guest, the housekeeping staff cleaning the room, management, and any other maintenance personnel that must have access to the room. The security key and electronic locking system not only allow access to the room, but also record such access for reporting purposes when the locking system is queried or interrogated. One example of the prior art locking system is disclosed in U.S. Pat. No. 5,477,041 to Miron, et al., the description of which is incorporated by reference herein.

At present, hotel operators' purchase the security locks systems including the locks found on the hotel doors, purchase a complete coding system for programming these security locks, and provide maintenance of the security locks. For example, a hotel manager may use a system like the SAFLOK Windows or the Vingcard Vision system, which allow the user to program or encode the security keys to the electronic locks at the hotel site. This involves substantial upfront costs, including the initial investment in the locks, the encoding software and hardware, and the costs involved with maintaining the system.

The instant invention provides the property manager with a lower cost alternative to purchasing the encoding equipment, or even having to purchase the locks.

This invention is equally applicable in other applications, including apartment buildings, college dormitories, and other multi-housing facilities. Although, the description of this invention will be described using the hospitality application, this invention can easily be adapted to these and other applications and key system software.

### SUMMARY OF THE INVENTION

The present invention allows a user to program, over the Internet, a security key for controlling access to an electronic lock. The invention comprises an electronic security lock, an electronic key, a magnetic or other electronic card encoder/reader (key-making station) for encoding the magnetic key card and reading the encoded key, a secure Internet connection preferably through an Internet Service Provider (ISP), and a remote server located at the lock and system manufacturer.

Unlike prior art systems where the electronic keys for secure access to the security locks are programmed on-site at the property, the instant invention contemplates having the user send a request to the remote server to have the security keys encoded. Additionally, software to generate and track key activity is housed at the remote server. The request for a key, a report or to perform some other key management function, made over the Internet by the hotel operator or other subscriber, accesses this software once the request has been authenticated and authorized, preferably through the use of a secure password and property security code. The operator signs on to the system and submits a key request and/or authorization request to the remote server. The server verifies the request and sends the encrypted key making data over the Internet to a magnetic card encoder or other key-making device at the property. A secure lock string is then encoded on the magnetic security key, which in turn activates the security lock on the door. When additional key making or other key management functions are required, then this same cycle of accessing the remote server and getting back a properly coded key or authorization would be repeated.

As envisioned under the invention, the locks and all related key coding equipment will remain the property of the service provider who could be the lock manufacturer or lock provider. This would allow all modifications and upgrades to the system to be performed directly by the service provider on behalf of the hotel operator or other subscriber.

The invention also contemplates authorization software that verifies that the hotel operator or subscriber is in good standing. The authorization software, according to the invention, will verify the amount remaining in the subscriber's account, and if this amount drops below a predetermined level, will send automatically-generated electronic messages to the subscriber informing the subscriber of this development, and explaining that service may be discontinued if the account is not brought above this critical level.

The invention further contemplates billing software that electronically arranges for payment of any fees owed by the hotel operator to the service provider. Different fee or payment arrangements are envisioned, and the software is modified accordingly. One option is for the subscriber to pay a mutually agreed monthly fee for the service and use of the equipment. Another option would be for the subscriber to pay for each request made to the remote server or for each transaction completed by the remote server. Another option, one particularly applicable to the hospitality industry, would be for payment to be based upon hotel occupancy rates, as reflected directly from the number of coded keys made and the length of stay information coded onto the security keys.

Once payment is received the lock system is re-activated. If the end-user fails to pay their service fee, their lock system is not activated for use, preventing the creation of room key cards and other key management functions. During such conditions, it is recommended that although guest and staff key cards are not empowered to be made by the system, temporary guest fail-safe key cards and existing master key cards remain operable for a limited time.

### BRIEF DESCRIPTION OF THE DRAWINGS

FIG. 1 is a block diagram showing the interconnections between the various components of the remote security key encoder according to the invention;

FIGS. 2A and 2B are flow diagrams detailing an example of the operation of the key encoding operation according to the invention;

FIGS. 3A-3C are flow diagrams detailing alternative authorization procedures according to the invention;

FIGS. 4A and 4B are flow diagrams detailing the account electronic fund transfer procedures according to the invention;

FIG. 4C is a flow diagram detailing an account replenishment procedure according to the invention; and

FIGS. 5-8 are various computer screen displays showing the various client functions and options.

### DETAILED DESCRIPTION OF THE PREFERRED EMBODIMENTS

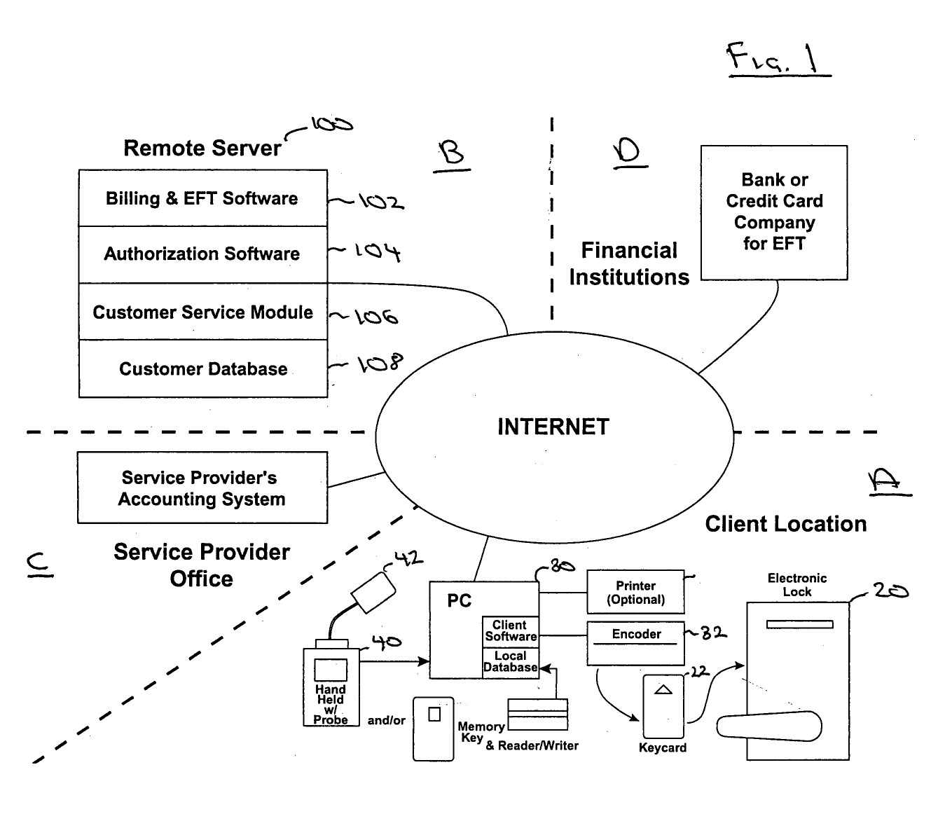

FIG. 1 is a block diagram giving an overview of the remote security key encoding process according to the invention. Referring to FIG. 1, the Internet is central to the invention. The interacting elements may be conceptually divided into sections as follows: Section A depicts the modules represented at the client or subscriber location and comprises the electronic lock, the lock-key interface, an on-site encoder, a client computer that is capable of accessing the Internet preferably through an Internet Service Provider or ISP.

Section B graphically represents the remote server and its functions, comprising the billing and electronic funds transfer (“EFT”) software, the authorization software, the customer service module and the customer database.

Section C represents the Service provider and illustrates that the service provider may have an office and accounting system that is removed from the remote server. Finally, Section D illustrates the separate banking element that allows for the EFT to take place and for the electronic verification of client funds status. The main element of each section will be described in greater detail below.

At the Property—Section A

Lock and Key Interface. The electronic lock 20 and key card 22 are shown in FIG. 1. The electronic lock and key interface is as described in U.S. Pat. No. 5,477,041 to Miron, et al., the description of which is incorporated by reference herein.

Client Computer. A client computer system 30 is employed, one preferably capable of Internet access, preferably through an ISP. The client computer 30 must be capable of running software for encoding the keys. This function is performed via an encoder 32 attached to the client computer 30. As envisioned in the instant invention, the lock manufacturer will provide the actual encoding software. In this scenario, the lock manufacturer will load the software onto the client computer 30 and provide training to use the software to the client.

Hand-held Unit. The client or subscriber uses a hand-held and/or electronic keycard lock programmer 40 and interrogator 42 for interrogating and programming the locks, setting the clock in the locks, and retrieving audit trail information. The hand held unit 40 interfaces with the host computer system and can download room/lock specific information. The hand-held unit 40 can then use this information to program the lock 20. For example, if the lock 20 on room 105 is removed for service, the hand-held unit 40 receives all information for room 105 from the host computer 30 and uses this information to program the replacement lock as room 105. Now, when keys are made for room 105, the replacement lock will respond appropriately. Although a hand-held unit is described, an electronic keycard may be substituted to provide the same functionality.

At the Remote Server—Section B

As illustrated in FIG. 1, the remote server 100 stores software related to encoding specific keys and authorizing other key system functions at the user/subscriber's request. The remote server 100, may be owned and operated by the service provider, and comprises the billing software 102, which incorporates the EFT software, the authorization software 104, and may include a customer service module 106. Also included as part of the remote server 100 is the customer database 108 that provides the remote server 100 with all information relating directly to each of the subscribers or clients.

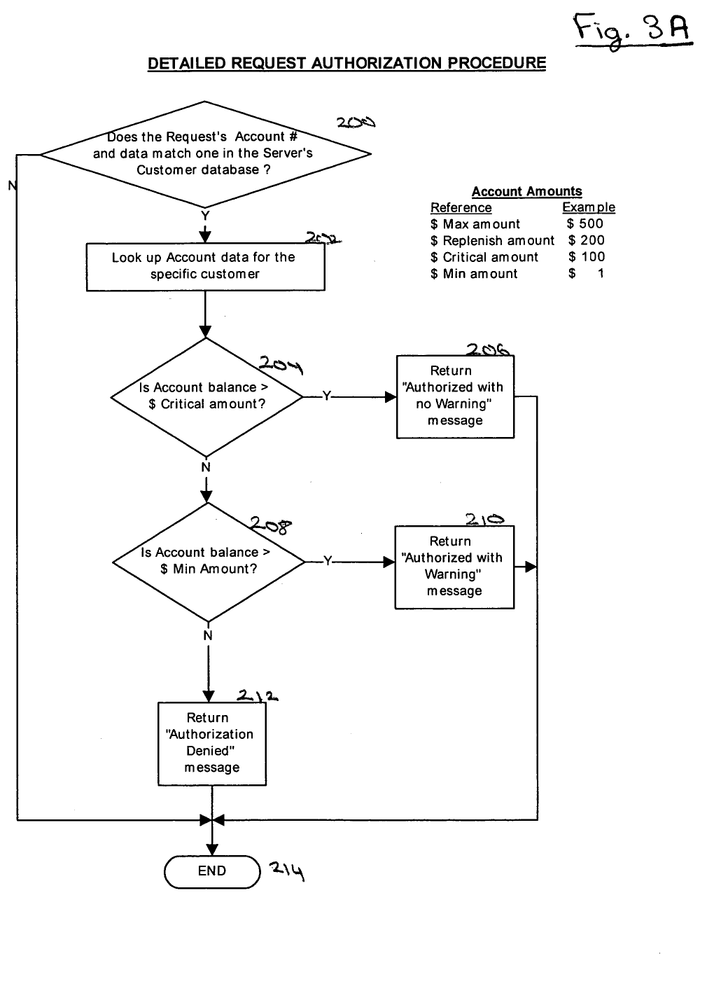

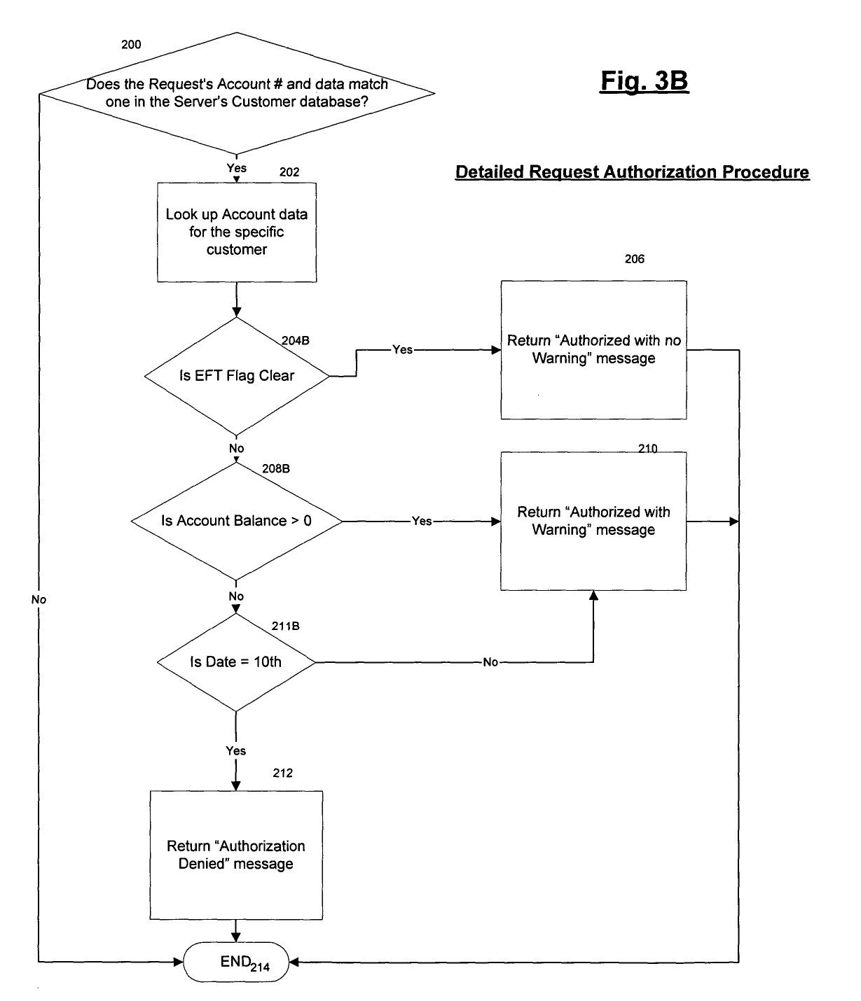

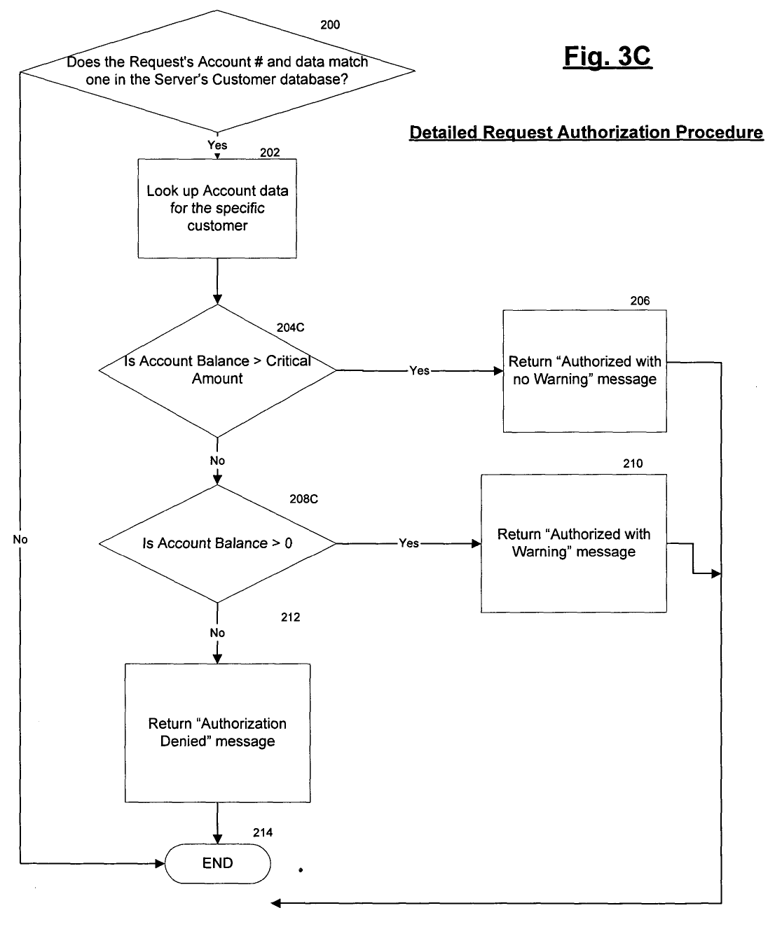

Authorization software: The authorization software 104 is described in greater detail with reference to FIG. 3. When a client makes a request for keys, the authorization software 104 will match the query to a particular client account and verify that the client is in good standing. This means that the client is current on all billing and has a solvent account. Also, the authorization software verifies that the request has indeed come from the correct property for which keys are being requested. Referring to FIG. 3A, in step 200 the remote server 100 first confirms that the requester's account number and data matches an entry in the customer database 108. If there is a satisfactory match, then the program goes to step 202 where the account data is accessed for the requester. Once the information is accessed, the program moves to step 204 and compares the requester's account data to a critical account amount. This critical account amount is an arbitrary figure that will be decided between the service provider and the client. Referring to the chart in FIG. 3A, a critical amount is set at, for example, $100. In this example, if the requester's account balance is greater than $100, the program moves on to step 206 and returns a message that communicates to the requester that the requested transaction is authorized. If the request is for a key, the server may include an encrypted key code as well.

If, however, the requester's account balance is less than the critical amount, the program moves to step 208 and asks whether the account balance is greater than some predetermined minimum amount. In this example, this minimum amount is set for $1. Once the requesters account is greater than this minimum amount, the program moves to step 210 and communicates that the transaction is authorized, but with a warning that the account is below the critical amount and needs to be replenished immediately. If, however, the requester's account is below this minimum amount, the program goes to step 212 and communicates a message to the requester denying the transaction.

In an alternative authorization procedure, as detailed in FIG. 3B, all transactions are conditioned upon the client having paid a monthly fee and upon the client paying any additional fees accrued at the end of the month before some arbitrary date, for example by the 10^{th} of the next month. As in the previous embodiment, the remote server 100 first confirms that the requester's account number and data matches an entry in the customer database 108 (step 200). If there is a satisfactory match, then the program goes to step 202 where the account data is accessed for the requester. Once the information is accessed, the program moves to step 204B to confirm whether the EFT flag is clear, meaning that any EFT attempt has been successful. If the EFT flag is clear, the program proceeds to step 206 and authorizes the transaction. If, however, the EFT flag has been raised, meaning that the program has attempted an unsuccessful electronic funds transfer, the program moves to step 208B and checks whether the account balance is greater than zero. If the account balance is positive, the program proceeds to step 210 and the transaction is authorized, however, with a warning message giving the state of the account. If the account balance is less than zero, the program moves to step 211B to check whether the final date for settling the account in full has passed. In this example, the program will check whether the 10^{th} day of the month is passed. If it is before the 10^{th} day of the month, the transaction is authorized, and a warning is attached (step 210). If, however, it is passed the 10^{th} of the month, and the account is less than zero, the transaction is denied and the corresponding message is sent to the client (step 212).

In yet another embodiment, as shown in FIG. 3C, the program may be set to determine whether the client's account is greater than some critical amount (step 204C), for example, 100 “units”, in which case the transaction is authorized with no warning message (step 206) or whether the client account is between this critical amount and zero (step 208C), in which case the transaction is authorized, but with a warning message. If the client account falls below zero, all further transactions are denied, without any grace period. According to the invention, a “unit” may be any measure desirable to the client. For example, a unit may be a single occupied hotel room night or it may reflect an entire hotel stay and correspond to the single key that is made.

Billing software: The billing software 102 is also resident at the remote server 100 and interacts closely with the authorization software module 104. It is currently envisioned that the application provider will receive payment in advance of providing the key encoding services. The client will set up a physical or electronic account with the service provider. The billing software 102 gives the service provider the option of assessing fees to the client or subscriber on a monthly fixed-fee basis, or under a “pay as you go” model based upon the number of requests, room occupancy, queries or transactions made of the remote server. The client account would then be debited as the key requests are made. Under the fixed-fee option, for example, the client would be able to make as many key requests as needed. Another way to assess fees, one particularly applicable to the hospitality industry, would be to base all billings on hotel occupancy information. The billing software would then track occupancy rate from the “start and end” or “days stay” information provided by the client software when a request for a coded key is made. For example, when a request is made to program a key for a particular room for 5 nights, the system records that the room lock will be in use for 5 nights and a corresponding deduction would be made to the client's account. Although it may be necessary to access the remote server or the service provider server to complete all billing and payment procedures, once the client's account has been replenished, the client may disconnect from all remote access, according to the invention, and generate encoded keys from the client's local system.

In a multi-housing apartment application, the key may be set to work for 365 days (1 year) but the client can be billed monthly and appropriate deductions made as the rent is received.

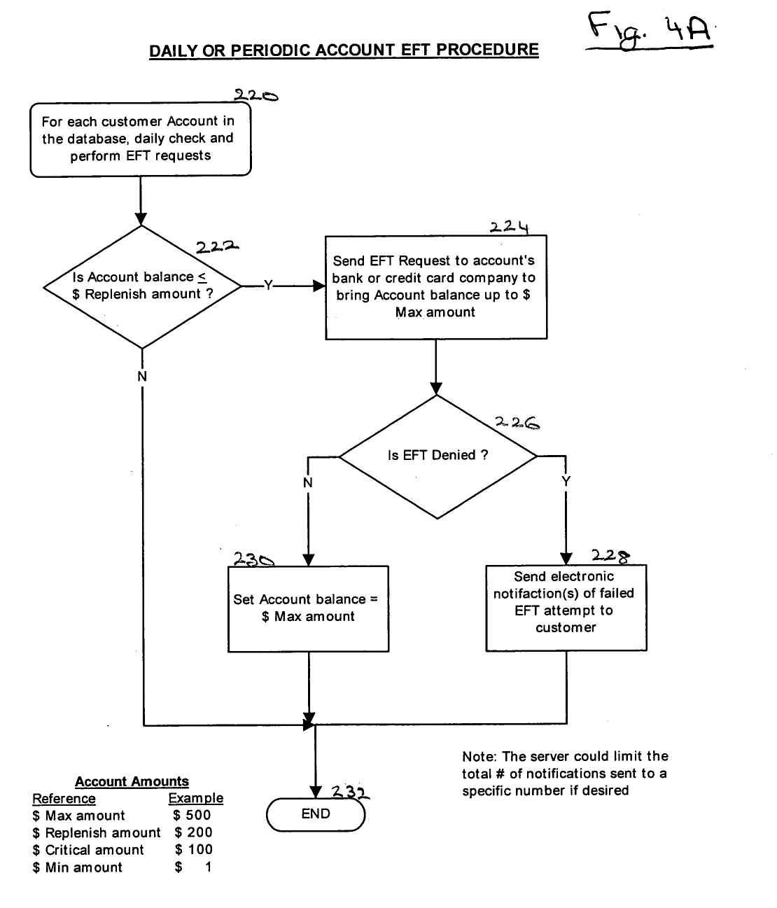

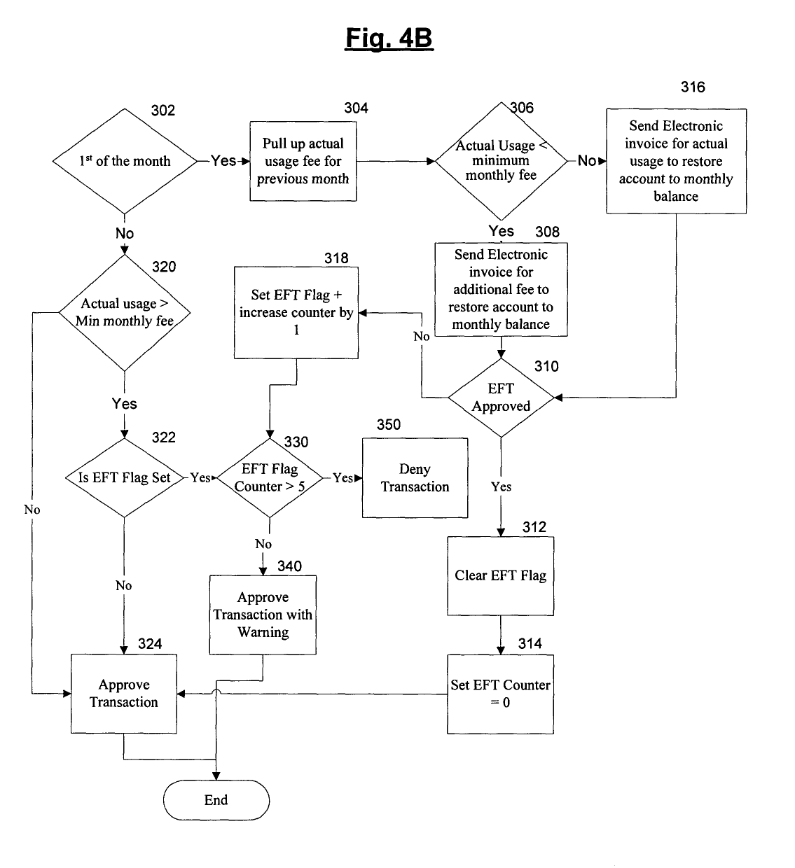

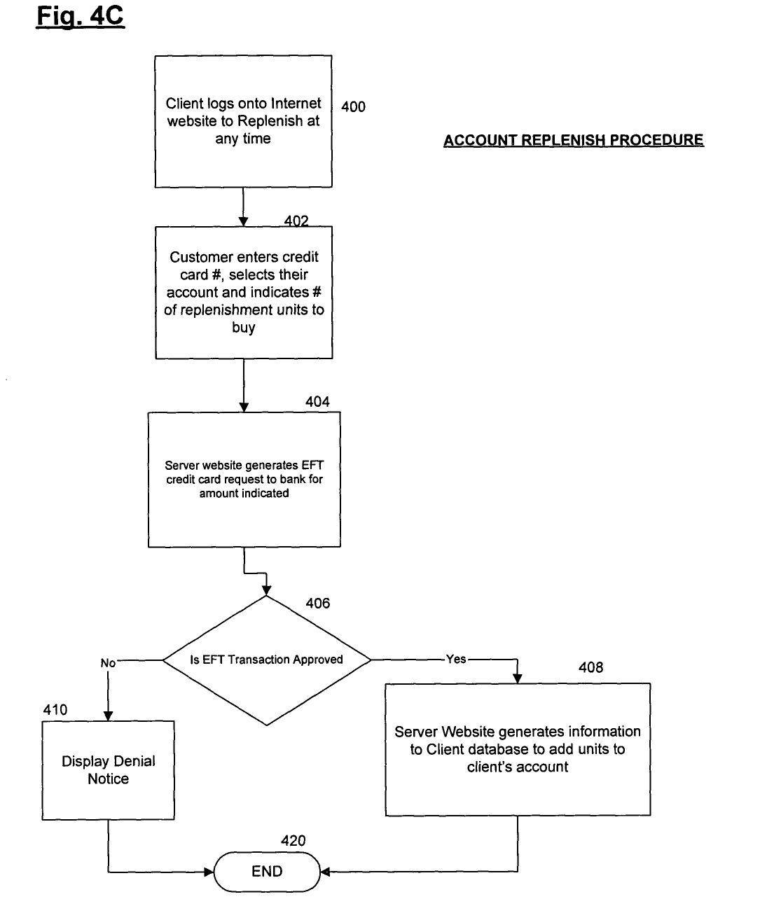

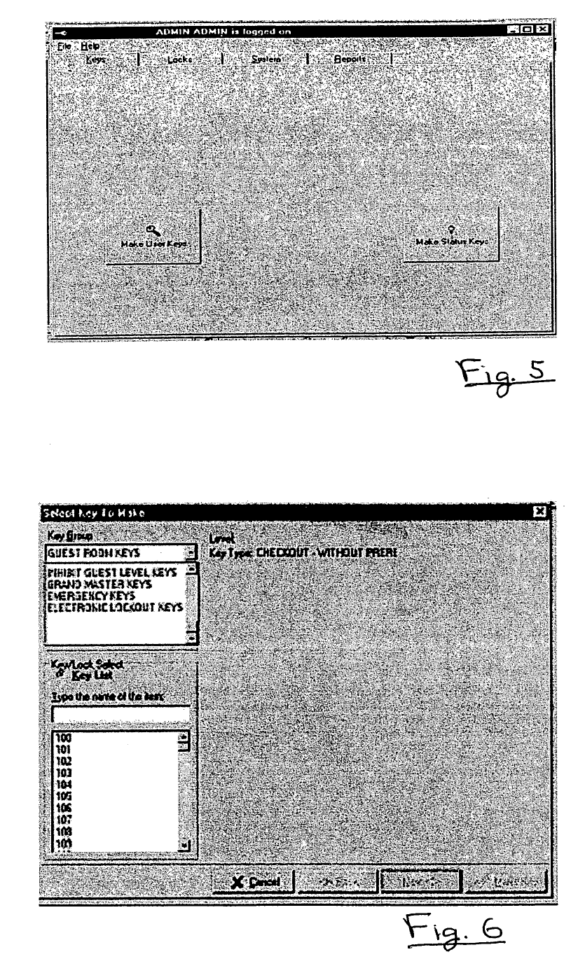

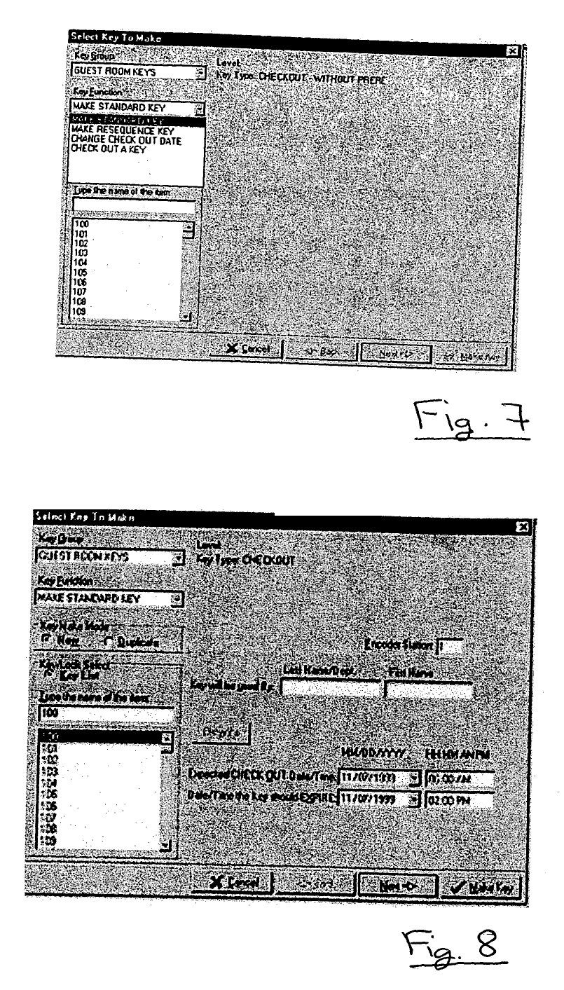

Another feature of the billing software 102 is the ability to automatically request payment, via an electronic funds transfer (EFT), from the client or subscriber's account under a predetermined protocol. Thus, when a client service account reaches a minimum level, the system will automatically request an additional fund transfer from the client bank account. If the request is approved, an appropriate message is sent to the authorization module, and the client's account balance is updated or replenished to the maximum amount. If, however, the request is denied, the remote server will notify the client electronically informing them that the account has reached a critical level, and that, unless replenished, additional key requests will only be authorized until the account is fully depleted. Once the client account is fully depleted, no additional key or other transaction requests will be honored. This operation is detailed with reference to FIG. 4.

Referring to FIG. 4A, the billing software 102 takes the first step 220 of querying each customer account in the customer database 108, preferably on a daily basis, and determines in step 222 which customer accounts are below a predetermined “replenish” amount. In this example, the replenish amount is set at $200.00. If the billing software 102 determines that a customer account is above the $200.00 replenish amount, then the software program 102 proceeds to step 232, completing this portion of the billing software function. If, on the other hand, the customer account is below this $200.00 replenish amount, then the software 102 goes to step 224 and sends an EFT request to the client/customer's bank or credit card company to bring the account balance back up to a maximum amount of, in this example, $500.00. After the request is made to the bank, the software 102 checks at step 226 to determine whether the EFT has been approved or denied. If denied, the program goes to step 228 and sends an electronic notification of the failed EFT attempt to the customer. In one embodiment of the invention, the program is set to limit the number of notifications a customer would receive when an unsuccessful EFT is attempted. If the transfer is successful, the program goes to step 230 and sets the account balance to the set maximum amount of, in this case, $500.00.

In an alternate embodiment of the invention, as detailed in FIG. 4B, the client pays a monthly fee based upon a monthly usage estimate, and only has to replenish the account once a month to cover both the monthly fee plus any additional fees corresponding to a usage level greater than the monthly estimate. Referring to FIG. 4B, the program queries the customer account in the customer database 108 as the customer logs on to the system to request a service. The first inquiry is whether it is the first day of the month (step 302). If so, the program proceeds to step 304 and pulls up the actual usage fee for the previous month. Next, the program determines whether the actual usage is less than the minimum monthly fee (step 306). If the actual usage is less than the minimum monthly fee, then the program proceeds to step 308, where an electronic invoice is sent to the client in order to restore the account to the minimum balance. Next, we determine whether the EFT is approved (step 310). If yes, the EFT flag is cleared (step 312). Next, the EFT counter is set to zero (step 314) and the transaction is approved. If, however, the actual balance is greater than the minimum monthly fee then the program proceeds to step 316 where an electronic invoice and EFT request is sent to the client for an amount equal to the minimum monthly fee minus the account balance. This simply replenishes the account to the minimum monthly balance. If the EFT is approved (step 310), then the program continues to step 312 where the EFT flag is cleared, the EFT counter is reset to zero (step 314). However, if the EFT is not approved, the program proceeds to step 318 where the EFT flag is set and the EFT counter is increased by 1. From step 318, the program proceeds to step 330 where the EFT counter is compared with a predetermined number, in this example, 5. If the counter is less than 5, meaning that the maximum number of unsuccessful EFT attempts has not been reached, then the program proceeds to step 324 and the transaction is approved, but with a warning message for the client. If however, the counter is greater than 5, the program goes to step 350 where the transaction is denied.

If this request occurs any other time during the month, the program proceeds from step 302 to step 320 where the client account is checked to see whether the client's actual usage is greater than the minimum monthly fee. If not, the transaction is authorized (step 324). If the actual usage is greater than the minimum monthly fee, the program moves to step 322 where the EFT flag is checked. If the flag is not set, the program moves to step 324 and the transaction is approved. However, if the flag is set, meaning that one or more EFT attempts have failed, the program moves to the step 330 to determine whether the maximum number of permitted EFT attempts has been exceeded. If not, the program moves to step 340, where the transaction is approved, but with a warning to the client. If, however the counter is greater than the predetermined number of attempts, the transaction is denied (step 350).

The billing software 102 may also be interrogated directly by the client computer 30 to provide the client with usage and account information, and with a simple way of replenishing the client's account. This feature is particularly useful to smaller users who may not have separate billing services. The billing software 102 could provide, for example, periodic reports of account usage, account balances and transaction histories. In the case of hospitality properties, the information would indicate percentage occupancy rates. FIG. 4C illustrates a preferred account replenishment procedure where the client accesses the client's database 108 via the Internet in order to replenish the account (step 400). This can be done at any time, at the client's convenience. Once into the client account, the client can enter a credit card number or other approved form of electronic payment, and specifies the number of units the client wants to purchase, or else the amount the client want to put on the account (step 402). For example, the client may anticipate a higher than normal occupancy rate during a particular season, and would, therefore, want to replenish the account in advance of this season. Next, the program would generate an EFT request directed towards the credit card company or to the client's bank account, for the amount specified by the client (step 404). The program then determines whether the EFT transaction is approved (step 406). If approved, the program goes to step 408 where the client's account data is updated. If the EFT transaction is denied, a denial notice is displayed (step 410). It is also envisioned as part of the invention that, once the local client's database account has been replenished and updated with the increased units, the client can log off the server and the Internet and generate keys and transactions on the client's local system. As the keys are generated at the local system, the local system software will automatically decrement the account database accordingly. Should the account reach a predetermined low amount before the client has signed back on to the Website to replenish it, a warning message would appear during transactions to prompt them to do so in the very near future.

Another feature in the billing software 102 would be that a portion of the occupancy or monthly usage revenue could be rebated electronically to the client parent company. This provides a monetary incentive to the parent company to choose this unique system over other systems.

Customer Service Module: The present invention also anticipates providing the client with access to a customer service module 106 resident on the remote server 100. This will provide the client with an opportunity to answer basic questions about the system, request documentation about the system, obtain reports of their most recent or even longer term occupancy, billing, key request transaction and other usage history, and provide other general system information.

Client—Server Interface

The system will be preferably a windows-based system as shown in FIGS. 5-8. This software could either be at the customer site resident on the customer computer 30, or accessed directly from the remote server 100 over the Internet. The client will provide the remote server 100 with, at a minimum, an access code, a user identification code and a property identification code. Once the client is validated, the client is given access to the application software that allows various functionalities for the user.

FIGS. 5-8 illustrate an example of the different windows the client could see as they request to encode a key using the system. Referring to FIG. 5, this first window display depicts the client name, the provider's name and the various functions the client could request, for example, making user keys (encoding the keys), making display keys used for interrogating the different lock display modes, or making status keys. The client will access the “Keys” folder and select the “Make User Keys” function box. Next, referring to FIG. 6, the user will select the “Guest Room Keys” in order to make new room keys. A window of all available room numbers for that particular property is shown for the user to eventually choose from.

Referring to FIG. 7, the client next selects one of the following functions:

Make standard key

Make resequence key

Change checkout date

Check out a key

If, for example, the user selects the “Make standard key” option, then the window allows the user to select either a new key or a duplicate key, as shown in FIG. 8. Now the client selects the room number (FIG. 8). Once the room number is selected, different data windows appear for the user to enter primary guest data, for example the guest name, the duration of stay, and check out times. In this example, the software automatically programs the key to expire at the checkout time plus, for example, eight hours. After this time, the key will not operate in the selected room, and a new key must be made.

Other functionality is available. For example, the operator may select other options like programming the key to access special areas within the property like the health club or the courtesy lounges or other restricted access areas.

Internet Connection Between the Client System and the Remote Server

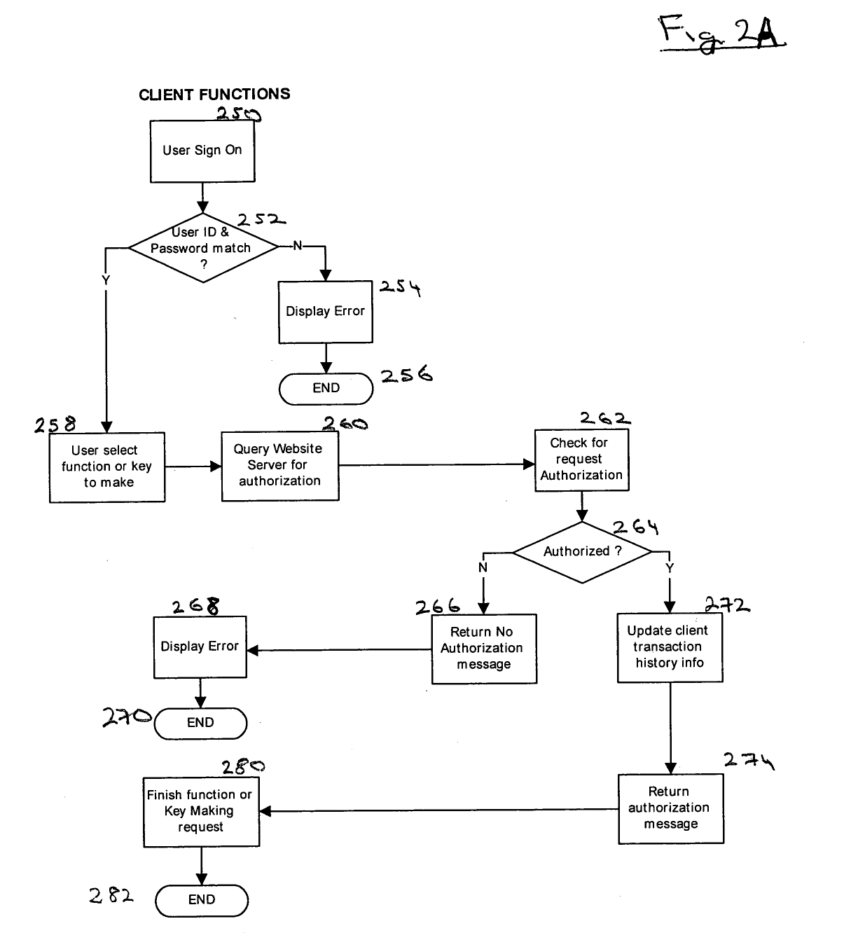

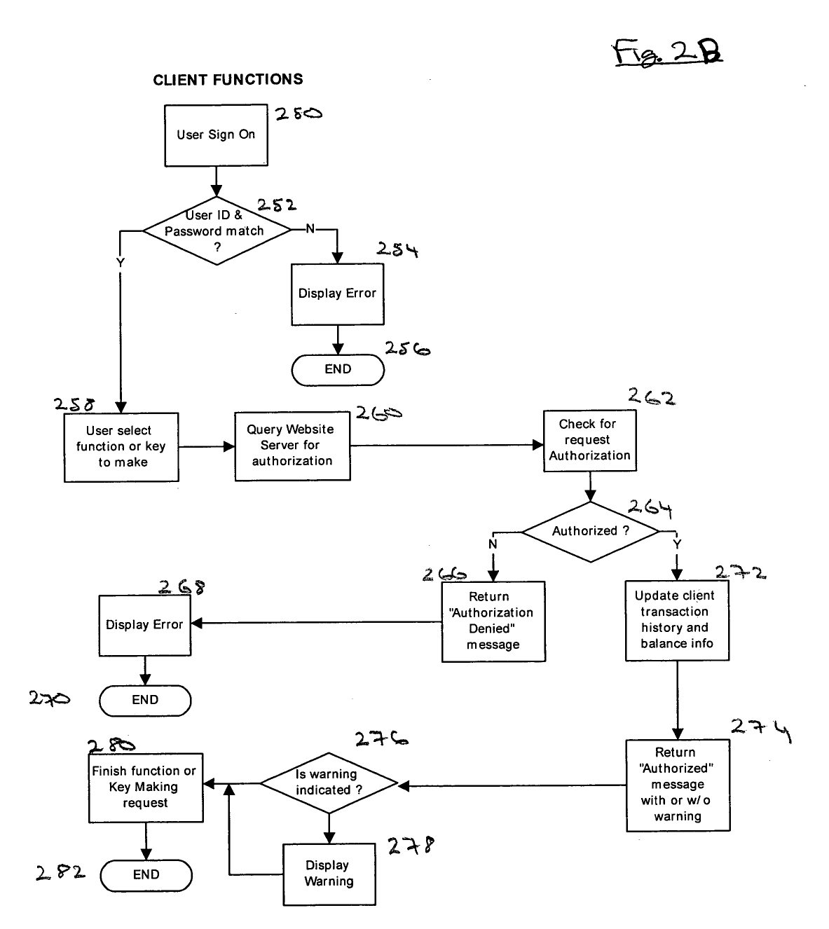

As envisioned by this system, the client will access the remote server 100 via the Internet. The client will be required to maintain its own Internet access and provide sufficient computer capacity and bandwidth to allow for timely transmission of data over the Internet. As stated above, the client software application may reside at the client site, on the client computer 30, or at the remote server 100. If at the remote server 100, the client will, in effect, access the manufacturers web site over the Internet and, after the appropriate verifications, transmit directly all key coding requests to the remote server 100. The general operating procedures are envisioned as illustrated in the flow diagram of FIGS. 2a and 2b.

Referring to FIG. 2a, the user first signs on to the system at step 250. The system first verifies that the user is a valid user by checking the user identification (ID) against a password or other form of verification medium (step 252). If the user ID and password does not match, an error message is displayed (step 254) and the system operation ends (step 256). If, however, the password and user ID match, the user may select the requested function from the Windows-based display, for example, request to make a key (step 258). The program next queries the remote server 100 for authorization to perform the requested function (step 260), requiring the implementation of the authorization procedure outlined with reference to FIG. 3 (step 262). If the authorization is denied, a message to that effect is generated and communicated to the user (steps 266 and 268) and the operation ends (step 270). If, however, the authorization is granted, the program updates the client's transaction history (step 272) and returns an authorization message (step 274) and possibly an encrypted key code if making a key. The client program then proceeds to perform the requested function, in this example, to make the key (step 280).

FIG. 2b illustrates the variation where the operation is authorized, but the client account is below the critical amount. In this case, a warning message is generated and communicated (steps 276 and 278) before the operation continues to comply with the request (step 280).

### Maintenance

Under the instant system, the lock manufacturer or system provider will own the locks and ancillary system equipment (encoders, hand held units, etc.) used at the property. As part of the service provided to the customer, the lock manufacturer or system provider will provide all maintenance for the locks, and provide general maintenance for the system. However, only normal wear and tear is included. Lock maintenance includes changing the lock batteries on a periodic schedule, cleaning the lock readers and encoders, and providing software updates, either on-site or from the remote location. It is clearly within the scope of the instant invention for the maintenance schedule or various maintenance alerts to be communicated to the client computer 30 via the remote server 100 or other automated means.

The foregoing description is exemplary, and does not serve to limit the invention. Accordingly, many modifications and variations of the present invention are possible in light of the above teachings. Although the preferred embodiments of this invention have been disclosed, one of ordinary skill in the art would recognize that certain modifications would come within the scope of this invention. It is, therefore, to be understood that within the scope of the appended claims, the invention may be practiced otherwise than as specifically described. For that reason, the following claims should be studied to determine the true scope and content of this invention.

What is claimed is:

1. A remote security key encoding system comprising:
a client system containing a client identity, a client location and client account information;
a service provider system connected to the client system via an Internet connection;
a financial institution system, connected to the client system and the service provider system via the Internet, such that, when, over the Internet a client requests the encoding of a security key, the service provider system identifies the client, authenticates the client location, confirms that the client's account status is above some predetermined threshold, and encodes the security key per the client request.

2. The encoding system as in claim 1, wherein the client system comprises an electronic lock, a lock-key interface, an on-site encoder, and a client computer system, the client computer system being capable of accessing the Internet.

3. The encoding system as in claim 2, wherein the client computer system accesses the Internet via an Internet service provider.

4. The encoding system as in claim 2, wherein the service provider system comprises a service provider account, billing software, electronic funds transfer software, authorization software, a customer database having client identification data, and a client service module.

5. The encoding system as in claim 4, wherein the service provider system is remotely located in a remote server.

6. The encoding system as in claim 5, wherein the financial institution system comprises software for providing electronic verification of a client's account status and software for electronically transferring funds from the client's account to the service provider's account.

7. The encoding system as in claim 6, wherein the remote server contains software for encoding security keys.

8. The encoding system as in claim 7, wherein the remote server contains software for authorizing security key system functions upon a request by the client.

9. A method for remotely authorizing a request to encode security keys from a service provider by a client, comprising the following steps:
matching the query to a specific client account, the client account having a unique client number with client information stored remotely in a client database;
verifying that the client request came from an authorized property properly requesting keys be made; and
verifying that the client is current on all billing and that the client account has a positive balance therein.

10. The method for remotely authorizing a client request as in claim 9, wherein the step of verifying that the client is current on all billing, further comprises the steps of:
confirming that the client number and client information match the data stored in the client database, and if the data matches; then
granting access to the account data by the client.

11. The method for remotely authorizing a client request as in claim 10, wherein the step of verifying that the client is current on all billing, further comprises the steps of:
comparing the account balance with a critical account amount, the critical account amount being selected by the service provider and the client, and if the account balance is greater than the critical account amount; then
communicating to the client that the request has been authorized; and
issuing the client an encrypted key code.

12. The method for remotely authorizing a client request as in claim 11, wherein the step of verifying that the client is current on all billing, further comprises the steps of:
comparing the account balance with a minimum account amount determined by the service provider and the client, the minimum account amount being an amount in the account below which all additional requests are denied; and if the account balance is greater than the minimum account amount but less than the critical account amount; then
communicating to the client that the request has been authorized; and
attaching a warning notice to the client along with the authorization, informing the client that the account balance is below the critical amount.

13. The method for remotely authorizing a client request as in claim 12, wherein the step of verifying that the client is current on all billing, wherein if the account balance is less than the minimum account amount, the following steps are taken:
denying the transaction;
electronically communicating with the client that the transaction is denied because the minimum account balance was reached.

14. A method for remotely authorizing a request to encode security keys from a service provider by a client, comprising the following steps:
matching the query to a specific client account, the client account having a unique client number with client information stored remotely in a client database,
verifying that the client request came from an authorized property properly requesting keys be made and, if so,
accessing the client data for the client,
determining whether the date of the request is before or after a predetermined client payment date,
if before the client payment date, authorizing the client request, and
if after the client payment date, determining whether an electronic funds transfer was made from the client into the client account, and if the electronic funds transfer was successful, authorizing the request.

15. The method for remotely authorizing a request to encode security keys from a service provider by a client as in claim 14, further comprising the steps of:
raising a flag whenever an electronic finds transfer request made by the service provide to the client is unsuccessful,
if the flag has been raised, confirming whether a balance reflected in the client account is greater than zero, and
if the client account balance is greater than zero, authorizing the request, and
communicating a warning message to the client that the electronic funds transfer was unsuccessful and giving the state of the account.

16. The method for remotely authorizing a request to encode security keys from a service provider by a client as in claim 15, wherein if the flag is raised, and the account balance is zero or below, then further comprising the steps of:
denying the request, and
communicating a warning message to the client that the electronic funds transfer was unsuccessful and giving the state of the account.

17. The method for remotely authorizing a request to encode security keys from a service provider by a client as in claim 16, wherein the balance in the client account is some unit of exchange, comprising individual room nights or a number of security keys.

18. A method for billing a client that makes a request for remotely encoded security keys, comprising the steps of:
periodically querying each customer account,
noting an account balance,
comparing the account balance in each customer's account to a predetermined replenish amount,
if the customer account is greater than the replenish amount, completing the billing program with an indication that the request be approved;
if the customer account is less than the replenish amount, sending a request to a financial institution identified by the client for funds to be transferred electronically into the client's account, and
verifying that the electronic funds transfer was successful;
if the electronic funds transfer is successful, then updating the customer account information to reflect the electronic funds transfer, and
completing the billing program with an indication that the request be approved,
if the electronic funds transfer is unsuccessful, then communicating electronically the failed funds transfer request.

19. A method for billing a client that makes a request for remotely encoded security keys, comprising the steps of:
matching the query to a specific client account, the client account having a unique client number with client information stored remotely in a client database,
verifying that the client request came from an authorized property properly requesting keys be made and, if so,
accessing the client account to determine an actual usage fee equal for services rendered to date,
determining the date of the request,
if the request is on the first day of the month, comparing the actual usage fee with a predetermined minimum monthly fee,
if the actual usage fee is less than the minimum monthly fee, invoicing the client requesting that funds sufficient to restore the account to the minimum monthly balance are transferred electronically into the client's account,
verifying that the electronic funds transfer is successful;
if the electronic funds transfer is successful, then clearing an electronic funds transfer flag and setting an electronic funds transfer counter to zero;
if the electronic funds transfer is not successful, then setting the electronic funds transfer flag and increasing the electronic funds transfer counter by a specified increment;
comparing the electronic funds transfer counter to a predetermined number equal to the maximum allowable electronic funds transfer attempts, and
if the electronic funds transfer counter is less than this predetermined number, then authorizing the client's request,
communicating a warning message to the informing the client of the electronic funds transfer attempts and the client account status.

20. The method for billing a client that makes a request for remotely encoded security keys, as in claim 19, wherein the request is denied if the electronic funds transfer counter is greater than this predetermined number, and a message communicating the reasons for the transaction denial is submitted to the client.

21. The method for billing a client that makes a request for remotely encoded security keys, as in claim 19, where the request is made on a date other than the first day of the month, further comprising the steps of:
comparing the actual usage fee with a predetermined minimum monthly fee,
if the actual usage fee is less than the minimum monthly fee, authorizing the request,
if the actual usage fee is greater than the minimum monthly fee, determining whether the electronic funds transfer flag is set,
if the electronic funds transfer flag is set, meaning that one or more unsuccessful electronic funds transfer attempts have occurred, comparing the electronic funds transfer counter to a predetermined number equal to the maximum allowable electronic funds transfer attempts, and
if the electronic funds transfer counter is less than this predetermined number, then authorizing the client's request, and communicating a warning message informing the client of the electronic funds transfer attempts,
if the electronic funds transfer counter is greater than this predetermined number, then denying the client's request,
if the electronic funds transfer flag is not, the request is approved.

22. A method for a client to replenish a client account, in which the client has direct access to the client account, comprising the steps of:
accessing the client account by the client,
determining how much credit the client would like to place on the account,
specifying from which financial institution the funds should originate
generating an electronic funds transfer of the funds from the financial institution into the client's account,
determining whether the electronic funds transfer is successful, and if so,
updating the client account,
if the electronic funds transfer is unsuccessful, communicating this fact to the client.

23. The method for a client to replenish a client account as in claim 22, where the client accesses the client account via the Internet.
